(19) United States
(12) Patent Application Publication
(10) Pub. No.: US 2016/0102694 A1
(43) Pub. Date: Apr. 14, 2016

(54) SUCKER ROD AND END FITTING WITH COMPRESSION PRESET

(71) Applicant: JOHN CRANE PRODUCTION SOLUTIONS INC., Sugar Land, TX (US)

(72) Inventors: Ryan Scott Gernentz, Midland, TX (US); Dustin Wayne Martin, Cypress, TX (US); Karol Hricisak, Sugar Land, TX (US)

(21) Appl. No.: 14/880,133

(22) Filed: Oct. 9, 2015

Related U.S. Application Data
(60) Provisional application No. 62/062,700, filed on Oct. 10, 2014.

(51) Int. Cl. F16B 11/00; E21B 17/04; F04B 53/14

(52) U.S. Cl. CPC F16B 11/008; F04B 53/144; E21B 17/04

(57) ABSTRACT

A sucker rod assembly comprising, an end fitting including a body with a rod receptacle cavity extending axially, a generally cylindrical sucker rod received within the rod receptacle cavity defining one or more annuli, a quantity of initially flowable adhesive bonded to the rod and disposed in the one or more annuli forming at least one wedge, a surface on the rod is spaced from a surface on the end fitting defining a void space therebetween, a blocking element is disposed between the surface on the end fitting and the surface on the rod, filling the void space. There is disclosed a blocking element in the form of a void filling incompressible material interposed between the end of the rod and the bottom end of the rod receptacle cavity. In one form, a collar is affixed to the rod and spaced relative to the lower open end of the rod. A blocking element is interposed between the collar and the lower open end of the end fitting.

### CROSS REFERENCE TO RELATED APPLICATIONS

This application claims benefit of U.S. Provisional Patent Application Ser. No. 62/062,700, filed Oct. 10, 2014, which is incorporated herein in its entirety by reference.

### BACKGROUND

This disclosure relates to an end fitting and sucker rod combination for a sucker rod used particularly in oil wells and similar applications.

Fiberglass composite sucker rods with metal end fittings connected to opposite ends are widely used to create a sucker rod string connected end-to-end for operating down-hole pumps and the like. Such technology is well known and described in U.S. Pat. No. 6,193,431 issued Feb. 27, 2001, entitled “Fiberglass Sucker Rod End Fitting,” the entire content of which is hereby incorporated by reference herein.

The end fitting includes a rod receptacle to receive the rod end. The receptacle defines a series of axially displaced areas which define wedge shaped annuli filled with initially flowable adhesive such as curable epoxy resin. Curing creates a series of hardened wedges formed of the epoxy connecting the end fitting and its associated rod end. The epoxy adheres to the outer surface of the rod. The wedges coact with the cavity profile of the receptacle to retain the rod end within the receptacle.

Among the mechanical forces acting on the rod-adhesive/metal interface, are compressive forces, such as during a stroke of the pump either up or down, and negative load forces. Negative load refers to forces acting on the side of the wedge opposite from the gripping side of the wedge. Negative load is very destructive to the wedges of prior art designs, causing catastrophic shear failure of the wedge. Here, however, when a shock load occurs that creates a negative load, the structure has the ability to absorb the negative load forces and to thereby resist failure of the rod connection.

In any end fitting design, the principle of the wedge is employed to provide capture of the fiberglass rod and distribution of the applied forces encountered in field use. The wedge is formed by a rod receptacle having an interior surface shaped to form at least one generally wedge-shaped annulus between the interior surface of the receptacle and the end of the rod received by the receptacle. The wedge-shaped annulus has an annularly thin portion and an annularly thick portion distal to the thin portion.

As is well known, during the assembly process, tension loading is applied to the rod relative to the end fitting. This load “sets” the wedges relative to the receptacle internal profile to insure transfer of the load between end fitting and rod. As is also well known, setting of the wedges results in a degree of axial translation of the rod relative to the end fitting cavity. Such axial translation diminishes the ability of the rod and end fitting combination to sustain negative loading because it introduces gaps or void spaces between the wedges and the end fitting internal cavity as well as the rod end and the bottom of the end fitting receptacle or cavity. What has been determined in the context of this disclosure is that the addition of mechanical elements, between the rod and its associated end fitting significantly improves the capability of the connection to withstand negative loading impacts.

Examples of end fitting designs include from five wedges (being the earliest designs) to one wedge. In each design, the shape of a wedge is determined by the diameter of the fiberglass rod, the shape of the receptacle cavity, and the length of each formed wedge or annuli. In all cases, areas of discontinuity and abrupt changes in the shape of the pocket lead to high stress levels, as revealed by stress analysis of the particular system. In the context of negative loads, examination of the stress distribution reveals that areas of high stress concentration are a product of the shape and size of the discontinuity of the end fitting pocket. These areas lead to destruction of the adhesive layer between the rod and end fitting, leading to catastrophic failure of the assembly.

There is a need, therefore, for a sucker rod end fitting combination which is particularly capable of withstanding negative loading.

### BRIEF SUMMARY OF THE DISCLOSURE

The contemplated advantageous result is provided by a sucker rod assembly, comprising, an end fitting including a body with a rod receptacle cavity extending axially, a generally cylindrical sucker rod received within the rod receptacle cavity defining one or more annuli, a quantity of initially flowable adhesive bonded to the rod and disposed in the one or more annuli forming at least one wedge to cooperate with the one or more annuli, a surface on the rod is spaced from a surface on the end fitting defining a void space therebetween, a blocking element disposed between the surface on the end fitting and the surface on the rod, filling the void space.

There is disclosed a blocking element in the form of a void filling incompressible material interposed between the end of the rod and the bottom end of the rod receptacle cavity. Also, a collar may be affixed to the rod and spaced relative to the lower open end of the rod which receives a blocking element interposed between the collar and the lower open end of the end fitting to resist inward axial movement of the collar and rod relative to the end fitting cavity.

These mechanisms are effective to transfer negative force loads from the rod to the end fitting thereby precluding exposure of the connection to destructive forces inherent in relative movement of the rod in the end fitting cavity under negative loading.

### BRIEF DESCRIPTION OF THE DRAWINGS

FIG. 1 is a sectional side view of a prior art sucker rod and end fitting.

FIG. 2 is partial sectional view on an enlarged scale of the sucker rod and end fitting of FIG. 1.

FIG. 3 is a sectional view of a sucker rod and end fitting assembly according to one embodiment of the disclosure.

FIG. 4 is a partial sectional view of a sucker rod and end fitting illustrating an initial state of another embodiment of the disclosure.

FIG. 5 is a partial sectional view of a sucker rod and end fitting according to the embodiment of FIG. 4 of the disclosure in a subsequent or completed state.

### DETAILED DESCRIPTION

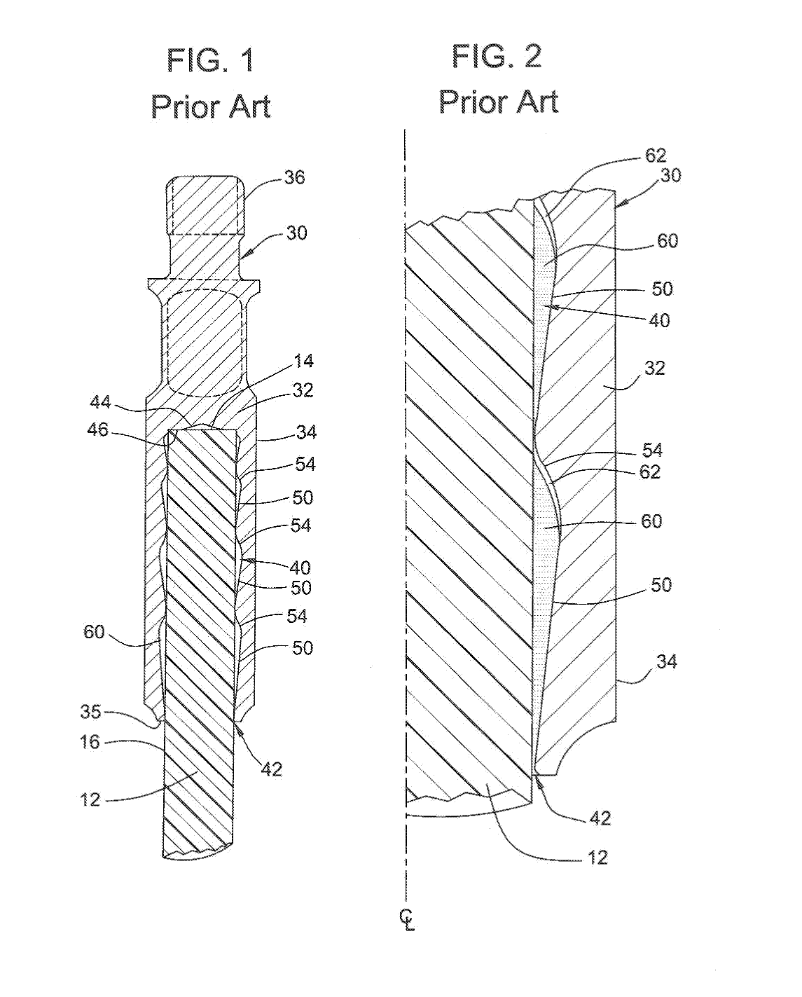

FIGS. 1 and 2 show an assembly of a prior art sucker rod and end fitting. The rod 12 is a composite fiberglass sucker rod of generally cylindrical cross section. Rod 12 has a metal end fitting 30 at each end. Multiple rod assemblies are coupled together to form a rod string for operating a down hole pumping mechanism. The string includes appropriate weighed elements to ensure that, under normal operating conditions, the string remains in positive tensile loading.

End fitting 30 comprises a longitudinally elongate body 32 symmetrical about a longitudinal centerline CL (seen in FIG. 2) with an external cylindrical surface 34. It has a threaded upper end 36 configured for connection of the assembly to a coupling (not shown) to form a rod string. Commencing at the transverse lower end 35 of body 32, end fitting 30 defines a rod receptacle or cavity 40 with an open end 42 and a bottom or closed end defined by pilot bore 44, sized slightly larger than the outer diameter of rod 12. Pilot bore 44 includes a transverse rod abutment surface 46.

Receptacle or cavity 40 has generally cylindrical interior surface comprised of a plurality of axially displaced voids denominated “annuli” for ease of understanding. As seen in cross-section, in FIGS. 1 and 2, each annulus is defined by a conical surface 50 that converges toward the open end 42 of the receptacle 40. Though in this illustrated embodiment, conical surfaces 50 are defined by a straight line revolved about longitudinal centerline CL surface 50 could be formed by a curved line as explained in U.S. Pat. No. 6,193,431. Conical surface 50 of each annulus merges with a transition surface 54 defined by a wave or “S” shaped curve that converges toward the bottom or closed end of receptacle 40. The transition surface 54 of each annulus merges with its immediately adjacent annulus at the narrowest end of coaxial surface 50 of the adjacent annulus. Notably, the annulus adjacent the open end 42 the coaxial surface 50 commences at a cylindrical surface that defines the entrance to the receptacle or cavity 40. The transition surface 54 of the annulus nearest the closed end of the cavity 40 merges smoothly with the pilot bore 44.

Thus, the interior surface of receptacle 40 defines a series of axially spaced voids tapered or converging toward the open end 42 and joined together at the opposite end by a smooth transition to the minimum transverse dimension of the rod receptacle or cavity 40.

Rod 12 is generally cylindrical in cross section with a transverse planar end or tip 14. It has an outer surface 16 sized to be received within the receptacle 40 with the rod end 14 seated in pilot bore 44. Rod end 14 initially abuts rod abutment surface 46. Typically, for rod diameters of 1 inch to 1.8 inches, the minimum transverse dimension of the cavity 40 exceeds the rod diameter by about 0.020 inch.

With the rod 12 inserted into the receptacle 40, the voids or annuli defined by surfaces 50 and 54 are annular with the outer perimeter defined by the surfaces 50, 54 and the inner diameter defined by the outer surface 16 of the rod 12.

As is well known, during assembly, the annuli are filed with an epoxy adhesive or other initially flowable material which is then cured or hardened to form solid wedges 60. In the assembly process, the receptacle or cavity is coated with mold release material to ensure that the epoxy forming the wedges 60 adheres only to the rod, and not the surface of the cavity surrounding the rod. As is also well known, the final step in the assembly process involves placing the rod in tension to “set” the wedges 60. Such tensioning causes some deformation of the molded epoxy resulting in the creation of annular voids 62 between the wedges and the transition surfaces 54.

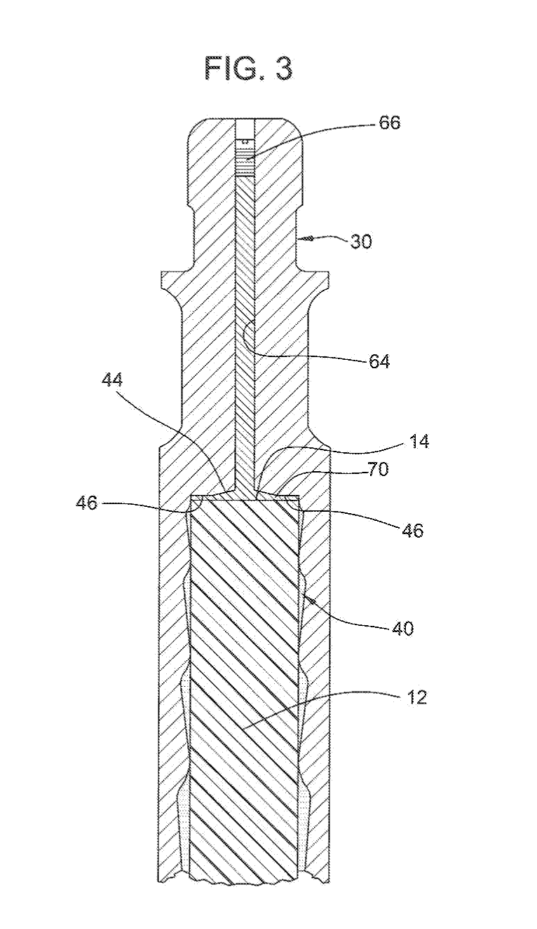

Turning now to FIG. 3, there is illustrated the incorporation of an abutment element in accordance with the present disclosure.

End fitting 30 and rod 12 are illustrated as joined together after the combination has been subjected to axial tension to “set” the rod. That procedure causes axial translation of the rod 12 and creates separation of the end 14 of the rod from the rod abutment surface 46 within pilot bore 44 at the innerward extent of the rod receptacle cavity 40. Ordinarily, absent the modification dictated by the present disclosure, such separation would eliminate the ability of transfer of force from negative loading through the rod end 14 to the abutment surface 46. The result would be diminished capability to withstand the deleterious effects of such loading upon the rod/end fitting combination. In accordance with the present disclosure an abutment element is incorporated into the end fitting 30 to rectify the foregoing deficiency.

As illustrated, end fitting 30 includes a central bore 64 open at an end that communicates with the end fitting rod receptacle cavity 40 at the pilot bore 44. The open end of bore 64 may be threaded so that it may be sealed by a removable threaded plug in the form of set screw 66.

In accordance with the disclosure, pilot bore 64 and any existing void space between rod end 14 and the abutment surface 46 of receptacle cavity 40 may be filled with an incompressible material sufficiently fluent to fill the void space and the central bore 64. One such fluid contemplated is the initially flowable epoxy adhesive used in forming the wedges 60. The central bore 64 may then be sealed closed with threaded plug or set screw 66. After filling the void space between rod end 14 and the abutment surface 46 of receptacle cavity 40, the set screw 66 is tightened until the void space and central bore 64 is filled with the incompressible fluid to the inner surface of the set screw. Thus, any force delivered to the incompressible fluid by inward urging of the rod 12 is transferred to the end fitting 30 at abutment surface 46 and/or the interconnection of set screw 66 with threaded bore 64.

On hardening or curing of the inserted flowable fluid, a blocking element 70 is created providing an impediment to axial movement of rod 12 inward, into rod cavity receptacle 40. Negative forces experienced by the rod 12 would transfer directly through blocking element 70 to be absorbed within end fitting 30 at abutment surface 46 and/or the threads of bore 64.

It should be understood that, while cured epoxy is suggested for formation of the void filling incompressible material, other incompressible materials may be used. For example, oil could be used. Any incompressible fluent material, solid or fluid, interposed between the end 14 of rod 12 and rod abutment surface 46 of the end fitting 30 would provide the advantages contemplated here. For example, propents useful in fracking operations might be suitable.

The advantage associated with the interposition of a blocking element of an incompressible material, such as an incompressible fluid, is that it fills the void space between the entire end surface 14 of the rod 12 and the entire surface area of the pilot bore 44 at the bottom of receptacle cavity, including transverse abutment surface 46. Thus, the forces associated with negative loading of the rod, that is, loads that urge the rod end into the receptacle cavity, are distributed over the entire area of the end of rod 12 and the entire area of pilot bore 44, including abutment surface 46, and not merely to the threaded connection of set screw 66 to central bore 64.

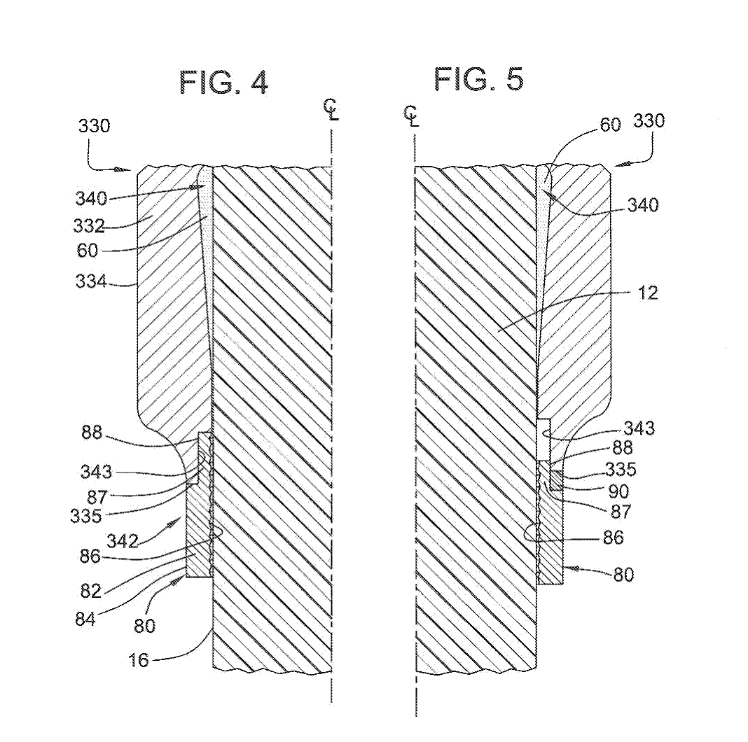

FIGS. 4 and 5 illustrate a further embodiment in accordance with the disclosure. Here, a sliding collar associated with the sucker rod 12 is incorporated into an end fitting to provide a mechanism to resist negative loading of the sucker rod within the end fitting receptacle.

Referring to FIG. 4, an end fitting 330 includes an elongated body 332 generally similar to body 32 of FIG. 1. The end fitting 330 has a lower open end 335 defining open end 342 of rod receptacle 340. A rod 12 is retained within rod receptacle 340 as described in connection with FIGS. 1 and 2.

In accordance with the disclosure, lower open end 335 of end fitting 330 includes a counter bore defined by cylindrical wall 343 spaced from the outer cylindrical surface 16 of rod 12.

Annular collar 80 is provided at the lower open end 335 of end fitting 330. It includes an annular body portion 82 defined by outer cylindrical surface 84 coextensive with the external cylindrical surface 343 of body 332 and an internal cylindrical surface 86 formed generally slightly larger in diameter than the outer cylindrical surface 16 of rod 12. As illustrated, cylindrical surface 86 may include a pattern such as knurling or spiral grooves, or similar discontinuities.

Collar 80 includes a cylindrical sleeve portion 87 having a cylindrical wall 88 disposed within and slidable relative to cylindrical wall 343 of the counter bore at the lower open end 335 of end fitting 330. It is contemplated that cylindrical wall 88 of sleeve portion 87 and cylindrical wall 343 of the counter bore at open end 342 are frictionally engaged, but that collar 80 may readily move axially outward from the lower open end 335 of end fitting 330.

At assembly of a rod end 14 of a sucker rod 12 into the receptacle cavity 340, a portion of the initially flowable epoxy is caused to enter between the outer surface 16 of rod 12 and the internal cylindrical surface 86 of collar 80. The cured adhesive affixes the collar 80 to the rod at the open end 342 of rod receptacle 340.

As previously explained, after curing, the rod/end fitting combination is subjected to tensile loading which “sets” the wedges 60. As illustrated in FIG. 5, such action results in axial translation of rod 12 relative to the rod receptacle 340. In the construction here, such axial translation causes the interconnection between collar 80 and the outer surface 16 of rod 12 to move axially away from lower open end 335 of end fitting 330. Cylindrical wall 88 of sleeve portion 87 moves in a telescoping fashion relative to cylindrical wall 343 of counterbore at the lower open end 335 of end fitting 330. The result is a gap or void space created between the lower open end 335 of the end fitting 330 and the collar 80 at the juncture of annular body portion 82 and sleeve portion 87 of collar 80. The consequence is an elongation of the assemblage of end fitting 330 and collar 80, with the creation of a gap between the collar 80 and the lower open end 335 of the end fitting 330.

In accordance with the disclosure, an annular blocking element 90 is placed in the gap to provide a direct path of force transfer from collar 80 to the lower open end 335 of end fitting 330. Axial force received by collar 80 urging it toward end fitting 330 is delivered through the attachment of the collar 80 to the rod surface 16 at the interface between these elements. That force is then directly delivered to the lower open end 335 of end fitting 330 through the interposed blocking element 90. (See FIG. 5)

The blocking element illustrated is a “C” ring or “snap ring” made of metal such as steel. Its axial length is determined by the axial length of the resultant gap between the extended collar 80 and the lower open end 335 of the end fitting 330 after setting the rod 12.

Any suitable blocking element could be placed in the gap, such as a “U” shaped element, or a circular element with separate halves appropriately hinged together. Also, any material suitable to receive compressive force such as the flowable adhesive or an epoxy could be used to fix the collar relative to the open end 335 of the end fitting. The important structural feature is that the blocking element 90 fills the spaced surfaces of the extended collar 80 at the juncture of body portion 82 and sleeve portion 87 and the adjacent lower open end 335 of end fitting 330 for direct transfer of force imparted to the sucker rod 12 by negative loading. The blocking element 90 fills the void space between these surfaces and transfers the force imparted by the rod 16 to the lower open end 335 of end fitting 330.

The advantages of the disclosed rod/end fitting combination are that it maintains the internal pre-load or reversed axial translation between the end fitting and the rod. As a result, the end fitting connection at the wedges will not unseat and cause premature release of the rod from the end fitting due to cyclic loading. In addition, due to the cyclic nature of the application, the alternating stress within the wedges remains constant which will lead to a longer life of the connection. Provided use of compression feature(s) on the end fitting, the overall assembly can still be API certified.

Variations and modification of the foregoing are within the scope of the present invention. It is understood that the invention disclosed and defined herein extends to all alternative combinations of two or more of the individual features mentioned or evident from the text and/or drawings. All of these different combinations constitute various alternative aspects of the present invention. The embodiments described herein explain the invention and will enable others skilled in the art to make and utilize the invention. The claims are to be construed to include alternative embodiments to the extent permitted by the prior art.

1. A sucker rod assembly, comprising:
an end fitting including a body with a rod receptacle cavity extending axially,
a generally cylindrical sucker rod received within said rod receptacle cavity defining one or more annuli therebetween,
a quantity of initially flowable adhesive bonded to said rod and disposed in said one or more annuli forming at least one wedge to cooperate with said one or more annuli,
at least one surface on said rod spaced apart from a surface on said end fitting defining a void space therebetween,
a blocking element disposed between said at least one surface on said rod and said surface on said end fitting filling said void space.

2. The sucker rod assembly of claim 1, wherein said rod receptacle cavity extends between a receptacle open end and a rod abutment surface, said rod having a transverse rod end spaced from said rod abutment surface defining said void space, said blocking element disposed between said transverse end of said rod and said rod abutment surface.

3. The sucker rod assembly of claim 1, wherein said end fitting includes a lower open end, and said assembly comprises a collar secured to said rod adjacent said lower open end defining said void space therebetween, and said blocking element is disposed between said collar and said lower open end of said end fitting.

4. The sucker rod assembly of claim 2, wherein said end fitting includes a lower open end, and said assembly comprises a collar secured to said rod adjacent said lower open end of said end fitting defining said void space therebetween, and said blocking element disposed between said collar and said lower open end of said end fitting.

5. The sucker rod assembly of claim 2, wherein said blocking element is an incompressible material.

6. The sucker rod assembly of claim 5, wherein said incompressible material is an incompressible fluent material.

7. The sucker rod assembly of claim 5, where said incompressible fluent material is an incompressible fluid.

8. The sucker rod assembly of claim 7, wherein, said incompressible fluid is said initially flowable adhesive in a solid state.

9. The sucker rod assembly of claim 7, wherein said incompressible fluid is oil.

10. The sucker rod assembly of claim 5, wherein a bore open to an outside of said end fitting body is in communication with said rod receptacle cavity and is closed with a plug, and contains said incompressible material in said bore.

11. The sucker rod assembly of claim 3, wherein said collar and said lower open end of said end fitting define a gap therebetween and said blocking element fills said gap.

12. The sucker rod assembly as claimed in claim 11, wherein said blocking element is a ring in said gap.

13. The sucker rod assembly of claim 11, wherein said end fitting includes a lower open end having a counter bore and said collar includes a body portion and a sleeve portion, wherein said sleeve portion is slidable within said counterbore and said gap is defined between said lower open end of said end fitting and said body portion of said collar.

14. The sucker rod assembly of claim 12, wherein said end fitting includes a lower open end having a counter bore and said collar includes a body portion and a sleeve portion, wherein said sleeve portion is slidable within said counterbore and said gap is defined between said lower open end of said end fitting and said body portion of said collar.

15. A sucker rod assembly as claimed in claim 14, wherein said blocking element is a ring in said gap.

16. A method of assembling a sucker rod, comprising:
inserting a generally cylindrical rod into a rod receptacle cavity of an end fitting, wherein the rod receptacle cavity has an interior wall defining one or more annuli;
curing an initially flowable adhesive within the one or more annuli to bond to the rod and to solidify to form a wedge in each of the one or more annuli to cooperate with the annuli;
applying tension to the rod relative to the end fitting to axially displace the rod relative to the end fitting and create a void space between an abutment surface of the rod receptacle cavity of the end fitting and an end of the rod; and
filling said void space with an incompressible material.

17. The method of claim 16, wherein the incompressible material is an incompressible fluid.

18. The method of claim 17, wherein the incompressible material is the initially flowable adhesive.

19. The method of claim 18, further comprising:
attaching a collar to the rod before applying tension to said end fitting relative to said rod; and
interposing a blocking element between the collar and the end fitting after applying said tension.

20. The method of claim 16, wherein said end fitting includes a lower open end and said method further comprises affixing a collar to said rod adjacent said lower open end prior to applying tension to the rod, wherein tensioning said rod axially displaces said collar relative to said lower open end of said end fitting to create a void space therebetween and said method further comprises placing a blocking element between said collar and said lower open end of said end fitting to fill said void space.
